(19) United States
(12) Patent Application Publication
(10) Pub. No.: US 2022/0324257 A1
(43) Pub. Date: Oct. 13, 2022

(54) ASSEMBLY FOR AN INNER TUBE

(71) Applicant: Nokian Renkaat Oyj, Nokia (FI)

(72) Inventors: Teemu SOINI, Nokia (FI); Hannu ONNELA, Nokia (FI); Jari OJALA, Nokia (FI)

(73) Assignee: Nokian Renkaat Oyj, Nokia (FI)

(21) Appl. No.: 17/701,912

(22) Filed: Mar. 23, 2022

(30) Foreign Application Priority Data
Apr. 7, 2021 (EP) 21397506.3

(51) Int. Cl. B60C 5/04; B60C 23/02; B29D 23/24

(52) U.S. Cl. CPC B60C 5/04; B60C 23/02; B29D 23/24

(57) ABSTRACT

An assembly (100) for an inner tube (110) for a tire or of an inner tube (110) for a tire, includes a base film (101, 201), which is forming a part of the inner tube (110) or configured to be attached to the inner tube (110). The assembly (100) includes a ring (102), which is inserted into a hole through the base film (101, 201), the ring (102) having internal threads of a fasten mechanism. The assembly (100) has a plug (103), which is removably insertable in the ring (102), the plug (103) including external threads of the fasten mechanism, a first end having a first surface (103a) adapted to face outwards a cavity of the inner tube when inflated, and a second end having a second surface (103b) adapted to face inwards the cavity of the inner tube and adapted for attaching a module (104) having an electronic device.

### CROSS-REFERENCE TO RELATED APPLICATIONS

This application claims priority benefit of Serial No. 21397506.3, filed Apr. 7, 2021 in Europe, and which application is incorporated herein by reference. To the extent appropriate, a claim of priority is made to the above-disclosed application.

### TECHNICAL FIELD

The disclosed solution relates inner tubes for tires.

### BACKGROUND

It is known that tires may be equipped with devices for sensing measures of interest such as air pressure within a tire. Such devices transmit the information via low-frequency radio to, for example, the vehicle's onboard computer, and to a corresponding display in the instrument cluster, if the vehicle is equipped with such display.

Tire-pressure sensors are typically integral to what is known as the Tire Pressure Monitoring System (TPMS), and said sensors are usually attached to the valve-stem assembly at the rim of each tire. Sensors may also be attached onto the inner liner of the tire by using adhesive or other mounting means.

However, the known solutions in the art are only suitable for vehicles, wherein the tires have no inner tubes. Some vehicles have inner tubes inserted into the tires to provide the airtight means for maintaining tire pressure. The solutions mentioned above are not suitable for those vehicles equipped with inner tubes, as it is not possible to access the air cavity for measuring at least temperature and pressure.

### SUMMARY

The disclosed solution is premised on an assembly for enabling a module comprising an electronic device to access the air cavity of an inner tube of a tire.

Thus, according to a first aspect of the disclosed solution, there is provided an assembly for an inner tube for a tire. There is also provided an assembly of an inner tube for a tire. The assembly comprises
a base film, which is forming a part of the inner tube or configured to be attached to the inner tube,
a ring, which is inserted into a hole through the base film, said ring comprising
   internal threads of a fasten mechanism,
a plug, which is removably insertable in the ring, said plug comprising
   external threads of the fasten mechanism,
   a first end having a first surface adapted to face outwards a cavity of the inner tube when inflated,
   a second end having a second surface adapted to face inwards the cavity of the inner tube and adapted for attaching a module comprising an electronic device.

The electronic device may for example a sensor, such as a sensor for sensing temperature and/or pressure. The assembly according to the disclosed solution enables the conditions inside the inner tube to be monitored accurately, thus making the driving safer.

The base film may be a part of the inner tube, thus offering an simplified manufacturing process of the inner tube comprising the assembly. The base film may also be a separate patch, thus allowing manufacturing the assembly at different premises than the inner tube. It is to be noted that the term “separate patch” used herein does not mean separating from the ring; rather, it means the patch is a separate, different item from the inner tube.

Further, the arrangement of the ring and the plug makes it a lot easier to change the module according to practical needs as compared to prior art solutions.

Thus, according to a second aspect of the disclosed solution, there is provided an inner tube for a tire. Said inner tube comprises an exterior surface and

an interior surface, the latter defining a cavity when the inner tube is inflated. Said inner tube further comprises
a ring, which is inserted into a hole through the inner tube, said ring comprising
   internal threads of a fasten mechanism,
a plug, which is removably insertable in the ring, said plug comprising
   external threads of the fasten mechanism,
   a first end having a first surface facing outwards the cavity of the inner tube,
   a second end having a second surface facing inwards the cavity of the inner tube and being adapted for attaching a module comprising an electronic device.

The disclosed solutions also include a sensor-assembly for an inner tube for a tire or of an inner tube for a tire, said sensor-assembly comprising any of the assembly disclosed herein, and a sensor.

In the second aspect, the ring may be inserted into a hole through a base film, which is a separate patch which has been attached to the exterior or the interior surface of the inner tube.

According to a third aspect of the disclosed solution, there is provided a method for attaching such assembly to an inner tube for a tire. The method comprises
preparing an assembly according to the disclosed solutions, wherein the base film is a separate patch,
making a hole on the surface of the inner tube, said hole is not smaller than the hole of the base film,
applying adhesive onto a contacting surface of the base film, wherein said contacting surface is to be contacted with the inner tube,
attaching the assembly to the inner tube while aligning the hole of the inner tube and the hole of the base film,
pressing the assembly to the inner tube while curing the adhesive.

As mentioned, the term “separate patch” used herein does not mean separating from the ring; rather, it means the patch is a separate, different item from the inner tube.

The main embodiments are characterized in the independent claims. Various embodiments are disclosed in the dependent claims. The embodiments and examples recited in the claims and in the specification are mutually freely combinable unless otherwise explicitly stated.

### BRIEF DESCRIPTION OF THE DRAWINGS

FIG. 1 shows a schematic drawing, by way of an example, of a cross-dimensional view of an assembly according to the disclosed solution.

FIG. 2a shows a schematic drawing, by way of an example, of a cross-dimensional view of the assembly shown in FIG. 1, attached to an inner tube, which is shown partially.

FIG. 2b shows a schematic drawing, by way of another example, of a cross-dimensional view of the assembly shown in FIG. 1 with slight variation, attached to an inner tube, which is shown partially.

FIG. 3 shows a schematic drawing, by way of another example, of a cross-dimensional view of an assembly according to the disclosed solution.

FIG. 4 shows a schematic drawing, by way of an example, of a perspective view of an inner tube, shown partially, comprising an assembly according to the disclosed solution.

The Figures are intended to illustrate the general principles of the disclosed solution. Therefore, the illustrations in the Figures are not necessarily in scale or suggestive of precise layout of system components.

### REFERENCE SIGNS

100 assembly
101 base film
201 base film
102 ring
103 plug
103a first surface
103b second surface
104 circumferential protruding shoulder
105 O-ring
106 module
110 inner tube (partly)
X direction of the axis of the ring
Z rotational axis of the inner tube
α angle

### DETAILED DESCRIPTION

Reference may be made to Figures. The disclosed solution relates to an assembly 100 for an inner tube. Preferably, such an assembly 100 is for an inner tube 110 for a tire. For example, such an assembly 100 may be for an inner tube for a tire for a heavy-duty vehicle, such as a tractor, a caterpillar, a harvester or a front loader; such tire can also be referred as heavy tire. The assembly 100 is adapted for attaching thereto a module 106 comprising an electronic device, such as a sensor.

According to the disclosed solution, the assembly 100 comprises a base film 101, 201. The base film 101, 201 serves as a base for other components of the assembly 100.

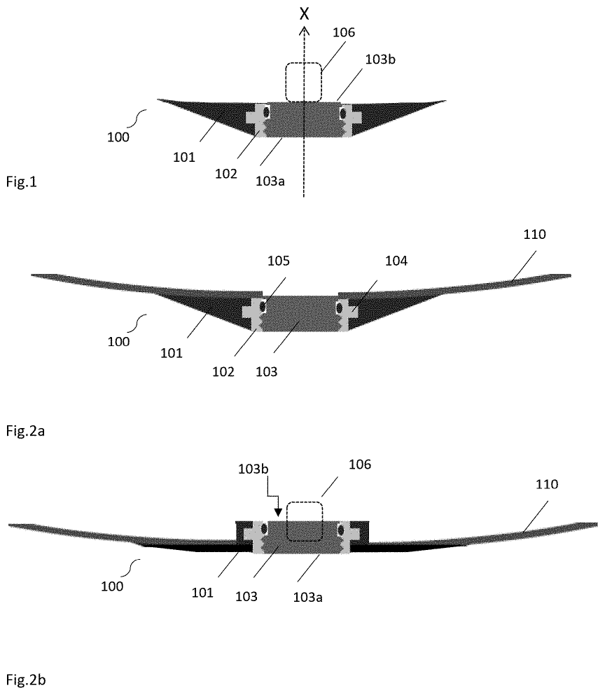

The base film 101 may be a patch, as illustrated in FIG. 1, FIG. 2a and FIG. 2b. The shape and dimensions of the base film 101 may vary according to practical needs. FIG. 2a and FIG. 2b show explanatory variations of the base film 101. The base film 101 as a separate patch can attach to the inner tube 110 by attaching the base film 101 to a surface of the inner tube 110, as illustrated in FIG. 2a and FIG. 2b. The base film 101 may be attached to the exterior surface of the inner tube, and thus the assembly 100 is suitable for any commercially available inner tube. Thus, the assembly 100 may be manufactured at a place where the equipment for manufacturing the inner tube is not necessarily required, and the assembly 100 having a small size as compared with an inner tube is easily stored and transported to inner tube manufacturers. On the other hand, the base film 101 may also be attached to the interior surface of the inner tube during 110 the vulcanization process of the inner tube 110, so that the external surface of the inner tube is kept even.

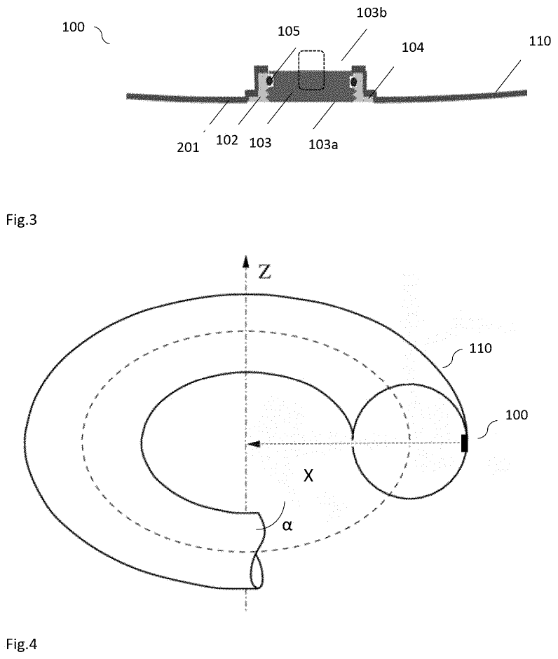

Alternatively, the base film 102 may also be forming a part of the inner tube 110, as illustrated in FIG. 3. In this case, a separate patch is not needed. In other words, the inner tube 110 serves as the base film 102 for other components of the assembly 100. This configuration simplifies the process of manufacturing the inner tube 110 comprising the assembly 100.

The assembly 100 further comprises a ring 102. The base film 101, 201 comprises a hole for the ring 102 to insert to. Thus, the ring 102 is laterally surrounded by the base film 101, 201. The ring 102 comprises internal threads of a fasten mechanism. The ring 102 provides mechanical support for the assembly 100 on the surface of the inner tube 110. The assembly 100 further comprises a plug 103, which comprises external threads of said fasten mechanism. The plug 103 can be inserted in the ring 102 by screwing, thereby forming the fasten mechanism. The inserted plug 103 can be removed from the ring 102 by screwing reversely without damaging the joining components, e.g. the plug 103 and the ring 102. Thus, the ring 102 and plug 103 together create a non-permanent joint. The internal threads of the ring 102 and the external threads of the plug 103 are designed so, that the fasten mechanism is substantially air-tight. Thus, the ring 102 and the plug 103 together prevent air leakage when the inner tube 110 is inflated.

An additional O-ring 105 situated between the ring 102 and the plug 103, when the plug 103 is inserted in the ring 102, may be used to further enhancing the air-tightness. The O-ring 105 made of elastic material may be for example seated in a groove of the internal threads of the ring 102 or of the external threads of the plug 103. When the ring 102 is inserted, the O-ring 105 is compressed and creating a seal at the interface. Also, an additional cover on top of the assembly 100 may be used to operate as an additional air barrier.

As can be seen in FIG. 2a, FIG. 2b and FIG. 3, the inner tube 110 also comprises a hole. In the example as illustrated in FIG. 3, the hole of the inner tube 110 is the hole of the base film 201. In the examples as illustrated in FIG. 2a and FIG. 2b, the hole of the inner tube 110 may not necessarily be of exactly the same size as the hole of the base film 101, as long as the module 106 can access the cavity of the inner tube, and the assembly 100 can cover the entire hole of the inner tube 110 when the plug 103 is inserted in the ring 102.

The base film 101, 201 preferably comprises elastic material, such as elastomer-based material. Preferably, the base film 101, 201 is made of a material comprising elastic material, such as elastomer-based material. In the case where the base film 201 is part of the inner tube 110, the base film 201 is naturally made of the same material as the inner tube 110, such as a material comprising natural and/or synthetic rubber, such as butyl rubber. In the case where the base film 101 is a separate patch, the base film 101 may be made of the same or a different material as the inner tube 110. As shown in FIG. 1 to FIG. 3, the ring 102 according to the disclosed solutions is inserted into a hole of the base film 101, 201. The base film 101, 201 may be attached to the edge of the ring 102 by, for example, using adhesive. Preferably, the base film 101, 201 is attached to the ring 102 via a curing process, thereby providing strong adhesion and good seal. Preferably, the base film 101, 201 comprises natural and/or synthetic rubber, and the base film 101, 201 is vulcanized to the ring 102.

The ring 102 advantageously comprises a material that provides rigidity, such as metal, alloy, polymer, or composite. Preferably, the ring 102 is made of a material comprising metal, alloy, polymer, or composite. Material comprising copper such as brass is preferable thanks to its good strength and atmospheric/aqueous corrosion resistance. Material comprising polymer such as polyamide is also preferable thanks to its good rigidity, durability and strength. Further, it is found that, a ring 102 comprises polymer, such as plastic, contributes the improvement of the audibility of a sensor installed to the assembly 100 via the module 106 on an inflated inner tube 110.

The dimensions, such as thickness, length, and diameter, of the ring 102 may be designed according to practical applications. It is preferable that the diameter of the ring 102 is no more than 40 mm, preferably no more than 30 mm, measured from the outmost edge of the ring 102, so that the running performance of the tire is well-maintained.

The ring 102 advantageously further comprises a circumferential protruding shoulder 104, which protrudes laterally outwards from the ring 102 and is embedded in the base film 101, 201, to further improve the strength of attachment between the base film and the ring. Preferably, the circumferential protruding shoulder 104 comprises at least one hole, which further enhances the attachment between the ring 102 and the base film 101, 201, as the uncurved material or adhesive for the base film can flow through the hole(s) when the base film 101, 201 is attached/adhered/vulcanized to the ring 102 and provide a firm binding after hardening.

The plug 103 advantageously comprises material that enables the radio frequency communication to take place. Metallic plug serves the purpose well. Further, a plug 103 comprising metal, such as brass, is dimensionally stable which facilitates the installation of the module 106 as well as the insertion of the plug 103 into the ring 102. However, using polymeric material is more preferable, for example nylon. It is found that by using polymeric material, such as nylon, as the material of the plug 103, the audible distance of a sensor installed to the assembly 100 on an inflated inner tube 110, is around four times longer than the using metallic plug. The audibility is further improved when both ring 102 and plug 103 comprise plastic, such as nylon.

The plug 103 according to the disclosed solution comprises a first end having a first surface 103a and a second end having a second surface 103b. When the plug 103 is being inserted into the ring 102 by screwing, the plug 103 moves in a direction X that is directed from the first surface 103a to the second surface 103b. Thus, the second surface 103b of the plug 103 is facing inwards the cavity of the inner tube 110 when the inner tube is inflated. The second surface 103b is adapted for attaching a module 106, which comprises an electronic device, such as a sensor. The design of the plug 103 may vary according to the practical needs. For example, the plug 103 may be a solid plug, where the second surface 103b is about the same level as the edge observing from a side view of the plug, as illustrated in FIG. 1. The plug 103 may also be a hollow plug, and the second surface 103b may be a depressed part of the plug 103 for accepting the module 106, for example as illustrated in FIG. 2b and FIG. 3. It is to be noted that the design of the plug 103 shown in a Figure is not necessarily linked to other components in the same Figure, but can be applied together with components shown in another Figure as well. The arrangement allows the module 106 comprising an electronic device to be situated inside the cavity of the inner tube, thus enabling the conditions inside the inner tube to be monitored accurately, thus making the driving safer. The plug 103 is removable, and thus it is easy to replace the module 106 when necessary.

The assembly 100 may further comprise a cover covering the first surface 103a of the plug 103 and the ring 102. The cover can on one hand, protect the ring 102 and the plug 103 from mechanical stress and, on the other hand, operate as an additional air barrier. Preferably, the cover is made of elastic material, such as butyl rubber.

The assembly 100 may be conveniently installed to any location of the inner tube 110. Preferably, the assembly 100 is installed to the outermost surface of the inner tube 110. For example, the assembly 100 is located at a location on the surface of the inner tube 110, whereby a direction of the axis X of the ring 102, said direction being directed from the first surface 103a to the second surface 103b, intersects and forms an angle α with the rotational axis Z of the inner tube, said angle α being equal or more than 85 degrees, and at most 95 degrees, as illustrated in FIG. 4. Thus, the location of the assembly 100 is close to the tread area of the tire, when the inner tube 110 is installed into the tire. This enables measurement of additional variables, such as load and more exact temperature of the tread area, compared to the installation on the, for example, innermost surface.

According to the disclosed solution, the ring 102 may be directly installed to an inner tube 110 using vulcanizing process.

Alternatively, the base film 101 may be a separate patch which is configured to be attached to the exterior or the interior surface of the inner tube. The separate patch, as mentioned, means it is a different item from the inner tube. Such an assembly 100 comprising a base film 101 which is a separate patch can be attached to the inner tube as the following method:
making a hole on a surface of the inner tube 110, said hole is not smaller than the hole of the base film 101,
applying adhesive onto a contacting surface of the base film 101, wherein said contacting surface is to be contacted with the inner tube 110,
attaching the assembly 100 to the inner tube 110 while aligning the hole of the inner tube 110 and the hole of the base film 101,
pressing the base film 101 to the inner tube 110 while curing the adhesive.

The method mentioned herein, preferably, before the step of applying adhesive, further comprises cleaning the contacting surface of the base film with acetone. This way the attachment between the base film 101 and the inner tube 110 is further enhanced.

In the method mentioned herein, preferably, the step of applying adhesive comprises applying two layers of adhesive with a time interval, such as one hour. This way the attachment between the base film 101 and the inner tube 110 is further enhanced.

The method mentioned herein, preferably, before the step of applying adhesive, further comprises roughing the contacting surface of the base film wire brush and/or sand paper. This way the attachment between the base film 101 and the inner tube 110 is further enhanced.

In the method mentioned herein, preferably, the step of curing is continued for a period of time which is at least two times longer than the required time for the adhesive to cure. This way the attachment between the base film 101 and the inner tube 110 is further enhanced.

1. An assembly for an inner tube for a tire or of an inner tube for a tire, comprising:
a base film, which forms a part of the inner tube or is configured to be attached to the inner tube,
a ring, which is inserted into a hole through the base film, said ring comprising:
internal threads of a fastening mechanism,
a plug, which is removably insertable in the ring, said plug comprising:
external threads of the fastening mechanism,
a first end having a first surface adapted to face outwards of a cavity of the inner tube when inflated,
a second end having a second surface adapted to face inwards of the cavity of the inner tube and adapted for attaching a module comprising an electronic device.

2. An inner tube for a tire, comprising:
an exterior surface, and
an interior surface, which defines a cavity when the inner tube is inflated,
a ring, which is inserted into a hole through the inner tube, said ring comprising:
internal threads of a fastening mechanism,
a plug, which is removably insertable in the ring, said plug comprising:
external threads of the fastening mechanism,
a first end having a first surface facing outwards of the cavity of the inner tube,
a second end having a second surface facing inwards of the cavity of the inner tube and being adapted for attaching a module comprising an electronic device.

3. The assembly according to claim 1, wherein the base film is an integrated part of the inner tube.

4. The inner tube according to claim 2, wherein the ring is inserted into a hole through a base film, which is a separate patch which has been attached to the exterior surface or the interior surface of the inner tube.

5. The assembly or the inner tube according to claim 4, wherein the base film comprises elastic material, such as rubber.

6. The assembly or the inner tube according to claim 1, wherein the ring comprises metal, alloy, polymer, or composite; and/or
wherein the plug comprises polymeric material, such as nylon.

7. The assembly or the inner tube according to claim 1, wherein the ring has a diameter no more than 40 mm, measured from the outmost edge of the ring.

8. The assembly or the inner tube according to claim 1, wherein the ring further comprises a circumferential protruding shoulder, which protrudes laterally outwards from the ring and is embedded in the base film.

9. The assembly or the inner tube according to claim 1, further comprising an O-ring, which is situated between the ring and the plug.

10. The assembly or the inner tube according to claim 1, further comprising a cover covering the first surface of the plug and/or the ring.

11. The inner tube according to claim 1, wherein the assembly is located at a location on the surface of the inner tube, whereby a direction of an axis of the ring, said direction being directed from the first surface to the second surface, intersects and forms an angle with a rotational axis of the inner tube, said angle being at least 85 degrees.

12. A sensor-assembly for an inner tube for a tire or of an inner tube for a tire, said sensor-assembly comprising the assembly according to claim 1, and a sensor.

13. A method for attaching an assembly to an inner tube for a tire, comprising:
preparing the assembly according to claim 1, wherein the base film is a separate patch,
making a hole on the surface of the inner tube, said hole is not smaller than the hole of the base film,
applying adhesive onto a contacting surface of the base film, wherein said contacting surface is to be contacted with the inner tube,
attaching the assembly to the inner tube while aligning the hole of the inner tube and the hole of the base film,
pressing the base film to the inner tube while curing the adhesive.

14. The method according to claim 13, further comprising,
before the step of applying adhesive, cleaning the contacting surface of the base film with acetone; and/or
before the step of applying adhesive, roughing the contacting surface of the base film wire brush and/or sand paper.

15. The method according to claim 13,
wherein the step of applying adhesive comprises applying two layers of adhesive with a time interval, such as one hour; and/or
wherein the step of curing is continued for a period of time which is at least two times longer than the required time for the adhesive to cure.

16. The assembly according to claim 1, wherein the base film is a separate patch which is configured to be attached to an exterior surface or an interior surface of the inner tube.

17. The assembly or the inner tube according to claim 4, wherein the base film comprises rubber; and the base film is vulcanized to the ring.

18. The assembly or the inner tube according to claim 1, wherein the ring comprises brass; and/or
wherein the plug comprises polymeric material, such as nylon.

19. The assembly or the inner tube according to claim 1, wherein the ring has a diameter no more than 30 mm, measured from the outmost edge of the ring.

20. The assembly or the inner tube according to claim 1, wherein the ring further comprises a circumferential protruding shoulder, which protrudes laterally outwards from the ring and is embedded in the base film; and wherein the circumferential protruding shoulder comprises at least one hole.

21. The assembly or the inner tube according to claim 1, further comprising a cover covering the first surface of the plug and/or the ring; wherein the cover is made of elastic material.

22. The assembly or the inner tube according to claim 1, further comprising a cover covering the first surface of the plug and/or the ring; wherein the cover is made of butyl rubber.
